(19) United States
(12) Patent Application Publication
(10) Pub. No.: US 2014/0315158 A1
(43) Pub. Date: Oct. 23, 2014

(54) Paper Craft Tool

(71) Applicant: Henry Wischusen, III, Duluth, GA (US)

(72) Inventor: Henry Wischusen, III, Duluth, GA (US)

(21) Appl. No.: 13/865,162

(22) Filed: Apr. 17, 2013

(51) Int. Cl. G09B 1/00

(52) U.S. Cl. CPC G09B 1/00
USPC 434/81

(57) ABSTRACT

A paper craft tool is disclosed. The paper craft tool is formed as a single piece, having a base that is formed generally in the shaped of a triangle with a rounded bottom section, a right side having an array of notched indentions, a corresponding left side having corresponding notched indentions, a first raised support having an array of peg supports disposed thereon, and a second raised support without an array of peg supports. A marking template is provided. A method and system utilizing the paper craft tool and marking template is provided.

### FIELD OF THE INVENTION

The technology described herein relates generally to paper craft devices and methods. In particular the technology described herein pertains to a paper craft device and method to facilitate paper folding and cutting.

### BACKGROUND OF THE INVENTION

The folding and cutting of paper to make two dimensional or three dimensional designs is well known in the art. Chinese and Japanese paper folding being some of the most popular art forms.

Origami from ori, meaning “folding”, and kami, meaning “paper” is the traditional Japanese art of paper folding, which started in the 17th century AD and was popularized outside of Japan in the mid-1900s. It has since then evolved into a modern art form. The goal of this art is to transform a flat sheet of paper into a finished sculpture through folding and sculpting techniques; the use of cuts or glue are not considered to be origami. Paper cutting and gluing is usually considered kirigami.

The number of basic origami folds is small, but they can be combined in a variety of ways to make intricate designs. The best known origami model is probably the Japanese paper crane. In general, these designs begin with a square sheet of paper whose sides may be different colors or prints. Traditional Japanese origami, which has been practiced since the Edo era (1603-1867), has often been less strict about these conventions, sometimes cutting the paper or using non-square shapes to start with.

Kirigami is a variation of origami that includes the cutting of the paper (from Japanese “kiru”=to cut, “kami”=paper). It is also called “Kirie”, from “Kiru”=to cut, “e”=picture.

Typically, kirigami starts with a folded base, which is then cut; cuts are then opened and flattened to make the finished kirigami. Kirigami is usually symmetrical, such as snowflakes, pentagrams, or orchid blossoms.

A difference between kirigami and the art of ‘pop up’ is that kirigami is made out of a single piece of paper that has been cut into a design. Pop ups can be made of several pieces glued together.

Mon-Kiri is the Japanese art of paper cutting.

Kirigami uses many of the same techniques as origami, but the craft also involves cutting and sometimes gluing. Symmetry is a very important element in Kirigami projects, which involves a few simple cuts to create a very complicated looking design.

In its most basic form, Kirigami encompasses the paper snowflakes, the paper doll, leaf, pumpkin mushroom, etc. chains created by children. Some of the more common Kirigami projects for adults include pop-up greeting cards, decorative gift-wrap, holiday decorations, and creative home decor.

Problems exist with consistent precise folding and cutting required, as well as finding templates, marking on the folded paper where cuts are to be made.

These and other problems need to be addressed.

Related patents and published patent applications known in the background art include the following:

U.S. Pat. No. D266,250, issued to Gallagher on Sep. 21, 1982, illustrates a funnel tray.

U.S. Pat. No. 4,490,916, issued to Blum on Jan. 1, 1985, discloses a template for providing multi-sided figures such as figures having 5, 6, or more sides. Essentially, the template is a planar member having a bottom apex. Directed from the apex, at a given angle, with respect to the horizontal, are two sides each of opposite slope. The member has a central vertical axis which is directed from the bottom apex and along which are a series of indicators spaced according to a desired length of a side. Positioned on the planar member are two slots which are parallel to the sloping sides emanating from the apex. Each indicator along the vertical axis is manifested by lines which are drawn from the indicator to the corresponding slot. In order to construct a polygon, the user emplaces a tack or pin through an indicator of the central axis to determine the length of the side and then marks the surface upon which the polygon is to be drawn by imprinting a mark where the connecting indicator line intersects the slot. A first corner is then scribed by marking two lines on either side of the apex. The unit is then rotated in position until a mark corresponds with a line on the opposing side. In this manner all corners of the figure are denoted in turn to provide the polygon of a given number of sides as determined by the apex angle.

U.S. Pat. No. 5,484,378, issued to Braithwaite on Jan. 16, 1996, discloses a method of folding a flat sheet of material into a decorative symmetrical object includes placing a sheet of flexible material such as paper between a male die member and a female die member and compressing the sheet. This will form crease lines in the sheet and partially fold the sheet. Completion of the folding to form the decorative symmetrical object is accomplished manually.

U.S. Pat. No. D379,155 issued to Bond on May 13, 1997, illustrates a rod diameter gauge.

U.S. Pat. No. D625,206, issued to Locascio on Oct. 12, 2010, illustrates a template for folding a specialized origami-like box.

U.S. Pat. No. D637,504, issued to Zieman on May 10, 2011, illustrates a patch-working template.

U.S. Pat. No. 7,951,058, issued to Pettersson on May 31, 2011, discloses a tool for the manual folding of a package blank into a package, includes a bottom plate with an abutment erect from the front edge of the bottom plate, a tongue protruding in front of the abutment from the front edge of the bottom plate, and a jaw acting against the tongue from above, as well as a lip protruding from the abutment, which is spring loaded and back-springing and which is retractable into the abutment against the spring force in dependence of the fact that a part of a package blank in one fold operation is made to pass by the lip, and which thereafter springs back to support the package blank in the attained folded position. A package blank, a method for preparing a package and the use of a tool for preparing a package by folding a package blank are also disclosed.

U.S. Pat. No. D640,943, issued to Tucker on Jul. 5, 2011, illustrates a quilt fabric template.

U.S. Published Patent Application 2005/0106995, inventor Kim and published on May 19, 2005, discloses various constructions of origami papers and origamis using the origami paper. The origami papers include one or more various features, such as luminescence, fragrance and pressured folding lines. The fragrance and luminescence features can be introduced to origami papers by forming one or more layers of luminescent and/or fragrant materials. The pressured folding lines can be made by compressing the origami paper or its base material. The origami papers make paper folding easier and the resulting origamis more attractive. Also, disclosed are an origami kit including the featured origami papers and a themed collection of origamis.

U.S. Published Patent Application 2006/0283922, inventor Hurwitz and published on Dec. 21, 2006, discloses an origami package and method for holding objects. In a preferred embodiment, the invention is a kit comprising: a substantially square sheet of material having a center and two pairs of opposing corners, said sheet of material having a first fold line (crease) that extends between a first of said two pairs of opposing corners, a first fold line pair each of which is disposed substantially perpendicular to said first fold line and is located between said center and one of said first of said two pairs of opposing corners, a second fold line pair, each of which is disposed substantially parallel to said first fold line and is located between said first fold line and one of said second of said two pairs of opposing corners, a third fold line pair, each of which is disposed substantially parallel to said first fold line and is located between one of said third fold line pair and one of said second of said two pairs of opposing corners; wherein said sheet of material is adapted to be foldable along said first fold line to produce a substantially triangular structure having two tips and a flap; wherein each of said tips is foldable along one of said fourth fold lines, said tips being engagable with one another when in a folded condition to produce an open packet having an opening and a slot; wherein said packet is foldable along said second fold lines to produce a closed packet; and wherein said closed packet is foldable along said third fold lines to produce a secured packet when said flap is inserted in said slot.

The foregoing patent, patent publication and non-patent information reflect the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein pertains to a paper craft tool and methods and systems thereof.

The paper craft tool is formed as a single piece, having a base that is formed generally in the shaped of a triangle with a rounded bottom section, a right side having an array of notched indentions, a corresponding left side having corresponding notched indentions, a first raised support having an array of peg supports disposed thereon, and a second raised support without an array of peg supports.

The first raised support and second raised support have their proximal ends equidistant from each other at the rounded bottom section and their distal ends intersect and combine into the point of the triangular apex of the paper craft tool. The result of this angled combination of the first raised support and second raised support is to form a recess between the first raised support and second raised support and the top side of the base of the paper craft tool therebetween. This recess provides an insertion area for corresponding folded paper.

In one embodiment of the technology described herein a first raised support cavity is formed along the length of the first raised support and a second raised support cavity is formed along the length of the second raised support.

At least one marking template is provided. The marking template is dimensioned for secure placement onto the paper craft tool, with the marking template having an array of holes corresponding to the array of pegs on the paper craft tool. In one embodiment the marking template is comprised of punch-out sections that are removed by a user prior to use in order to form marking openings. The marking template can be formed of metal, e.g., aluminum or stainless steel, plastic, cardboard, paper, or other suitable material. In some embodiments of the technology described herein the marking template is formed with marking openings with no punch-out sections.

When a paper has been properly folded and inserted into the recess of the paper craft tool and a marking template securely placed over the combination of the paper craft tool and folded paper, a marking instrument, e.g. a pencil, is used to trace onto the folded paper an area to be removed by cutting, e.g. by scissors, knife, etc.

The method of using the technology described herein is comprised of
a. Obtaining a paper craft tool, a marking template, a square sheet of paper, a marking instrument and a cutting instrument;
b. Folding the sheet of paper in half to create a folded edge;
c. Placing the paper craft tool along the folded edge with the apex of the paper craft tool on the folded edge and the left side notch (matching the paper size) aligning with the proximal end of the right vertical side of the folded paper;
d. Folding the left corner of the paper towards the paper craft tool right side such that it is aligned with the paper tool right side;
e. Removing the folded paper and flipping it over;
f. Folding the bottom left corner to align with the right diagonal edge;
g. Folding the top left corner to align with the right diagonal edge;
h. Flipping over the folded paper;
i. Folding the right edge toward the left edge;
j. Placing the folded paper into the paper craft tool recess;
k. Removing punch-out sections from the marking template (if any);
l. Placing the marking template onto the paper craft tool with the folding paper therebetween;
m. Using the marking tool to trace on the folded paper using the punch-out sections as a guide;
n. Removing the folded paper from the paper craft tool recess;
o. Cutting the folding paper along the tracings; and
p. Unfolding the folded paper.

There has thus been outlined, rather broadly, the features of the present invention in order that the detailed description that follows may be better understood, and in order that the present contribution to the art may be better appreciated. There are additional features of the invention that will be described and which will form the subject matter of the claims. Additional aspects and advantages of the present invention will be apparent from the following detailed description of an exemplary embodiment which is illustrated in the accompanying drawings. The invention is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein will be better understood by reading the detailed description of the invention with reference to the accompanying drawing figures, in which like reference numerals denote similar structure and refer to like elements throughout, and in which:

FIG. 1 is a top plan view of a paper craft tool, according to an embodiment of the technology described herein;

FIG. 2 is a bottom plan view of the paper craft tool of FIG. 1;

FIG. 3, is a top perspective view of a paper craft tool, according to an embodiment of the technology described herein;

FIG. 4, is bottom perspective view of the paper craft tool of FIG. 3;

FIG. 5 is a top perspective view of the paper craft tool of FIG. 3, illustrating in particular a paper marking template inserted thereon;

FIG. 6 is a top perspective view of a paper craft tool, a folded paper and a paper marking template with punch-out pieces removed, according to an embodiment of the technology described herein;

FIG. 7 is a top perspective view of an assembled paper craft tool and paper marking template, illustrating the placement of a folded paper in the assembly;

FIG. 8 is a top perspective view of an assembled paper craft tool, a folded paper and a paper marking template, illustrating the marking of portions of the paper to be cut and removed;

FIG. 9 is a top perspective view of the assemble paper craft tool, illustrating, in particular the removal of the marked folded paper;

FIG. 10 illustrates the cutting and removal of the marked sections of the folded paper;

FIG. 11 illustrates an unfolded paper after marked sections have been cut and removed from the folded paper;

FIG. 12 illustrates a paper marking template, illustrating, in particular, the punch-out sections still inserted in the template, according to an embodiment of the technology described herein;

FIG. 13 illustrates the paper marking template of FIG. 12, illustrating, in particular the punch-out sections removed;

FIG. 14 illustrates the first three steps of a method for using a paper craft tool, according to an embodiment of the technology described herein;

FIG. 15 illustrates steps four through nine of a method for using a paper craft tool, according to an embodiment of the technology described herein; and

FIG. 16 illustrates steps 10 through 12 of a method for using a paper craft tool, according to an embodiment of the technology described herein.

### DETAILED DESCRIPTION OF THE INVENTION

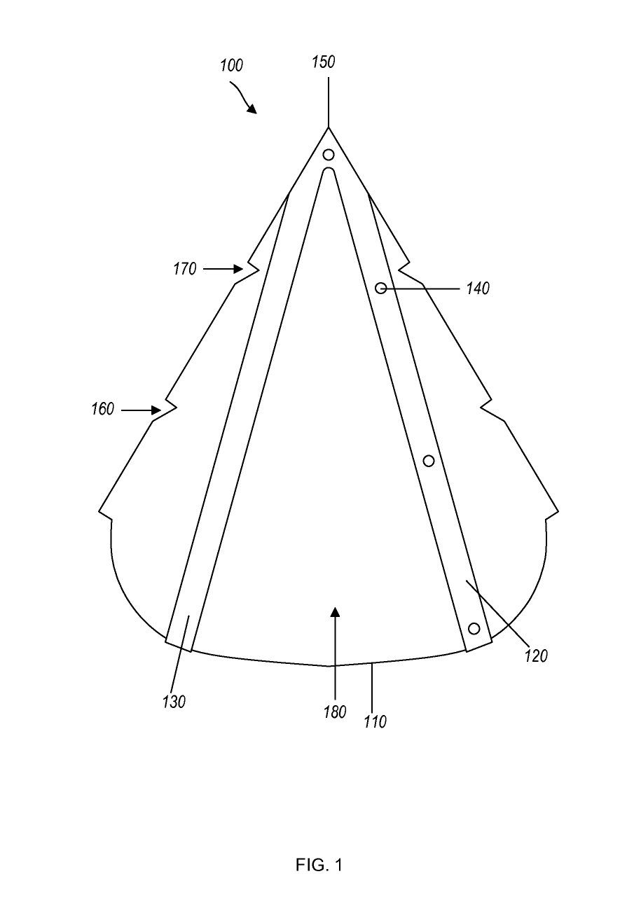

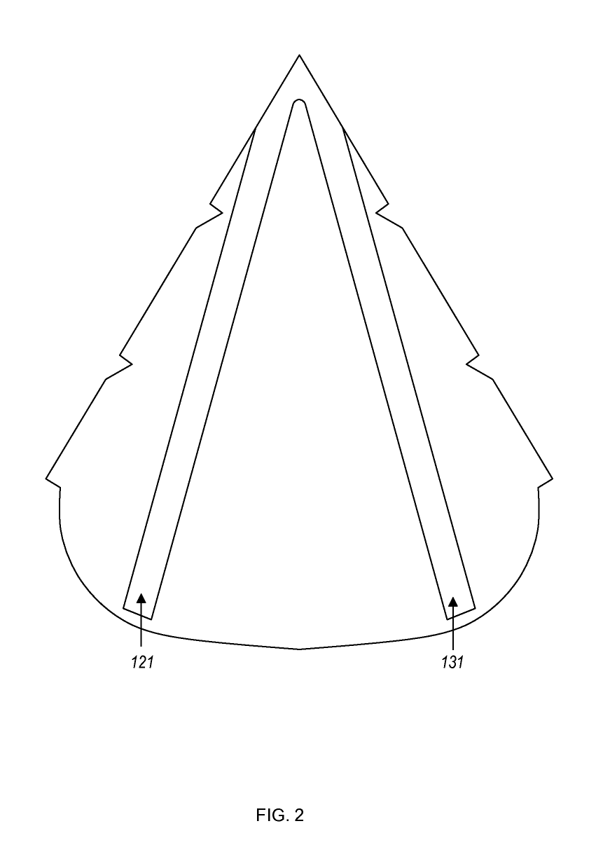

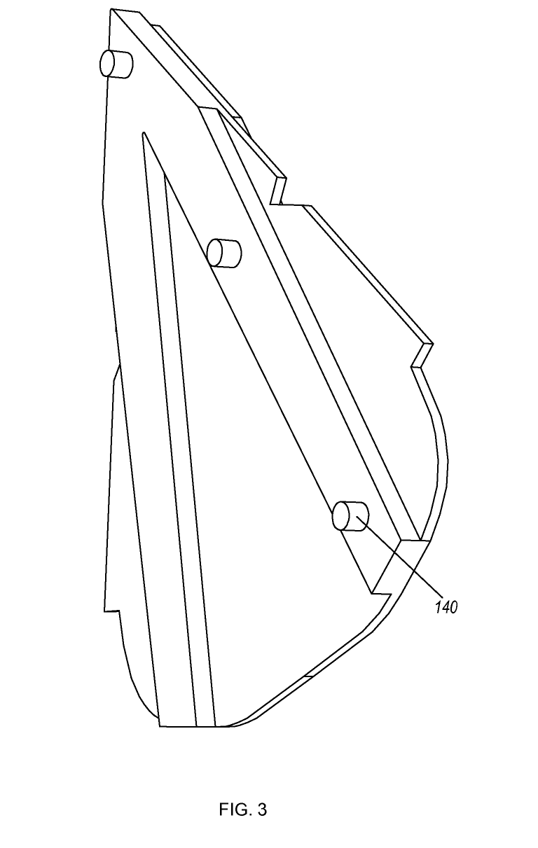

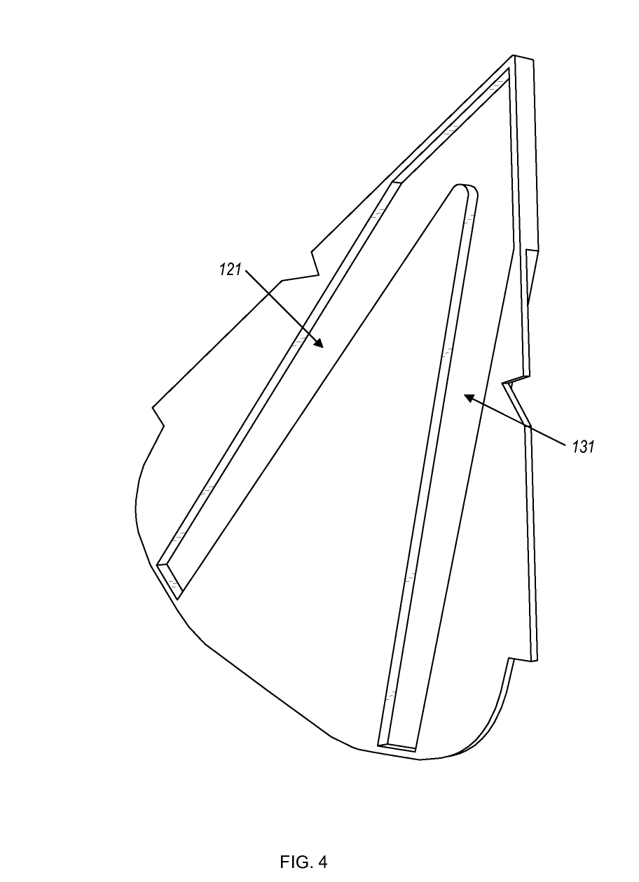

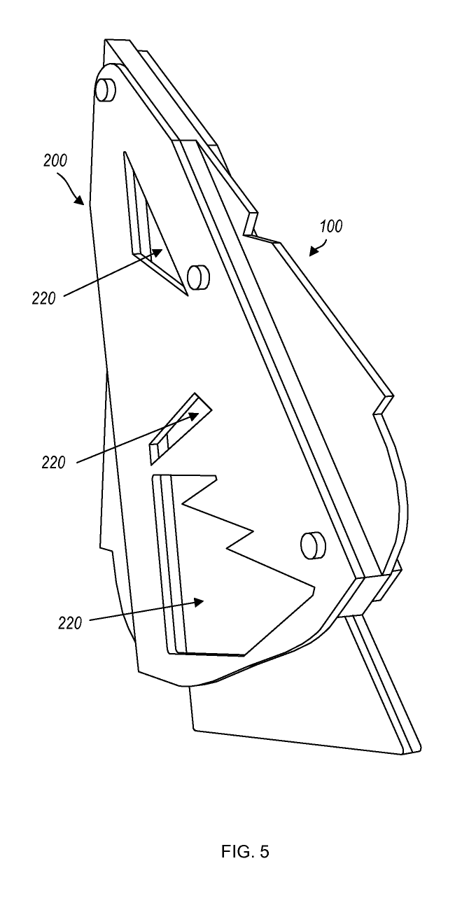

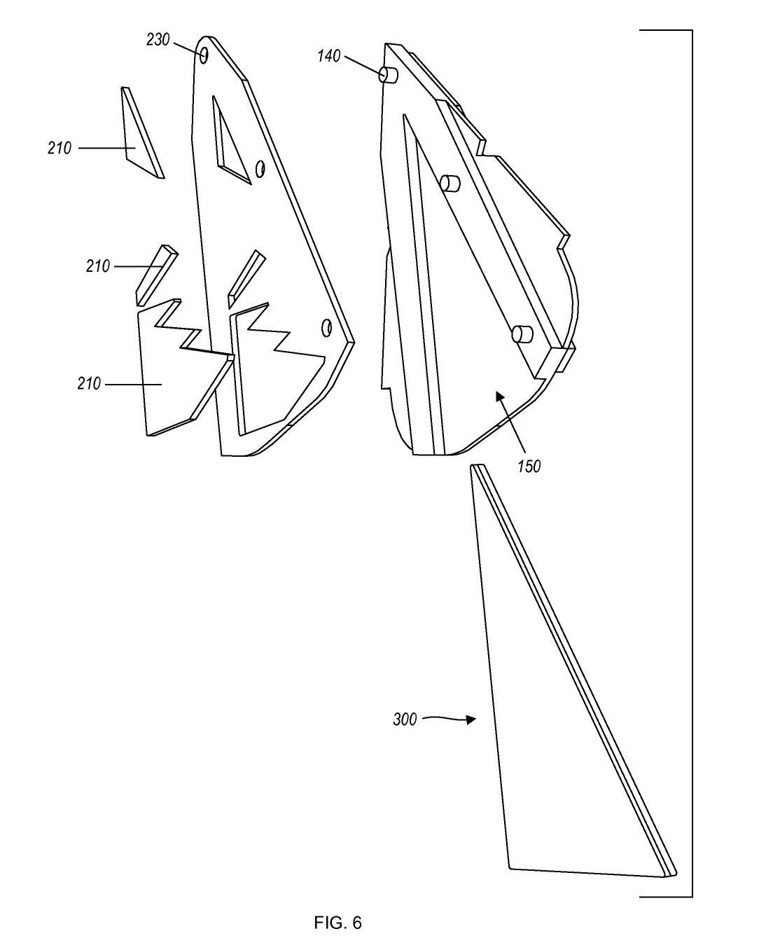

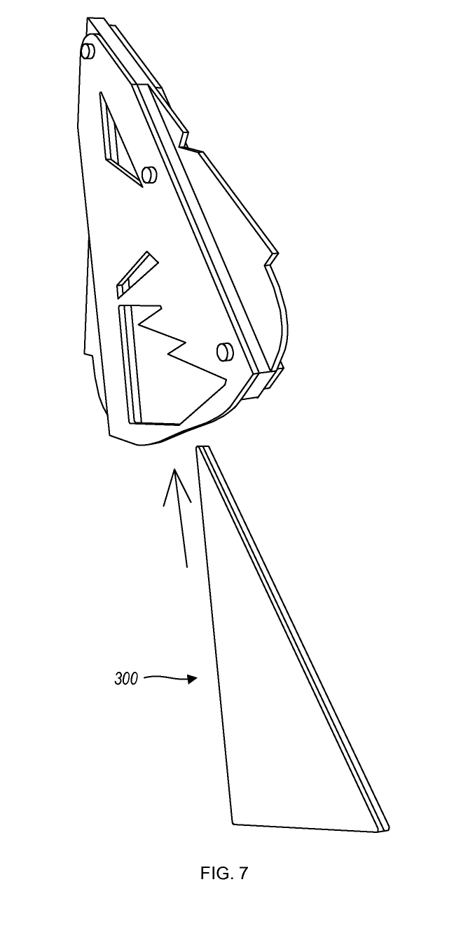

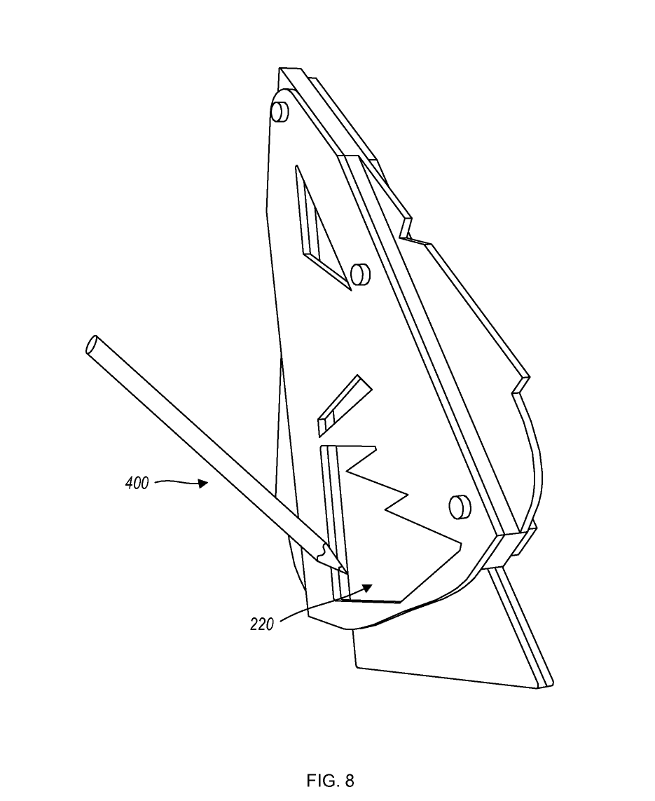

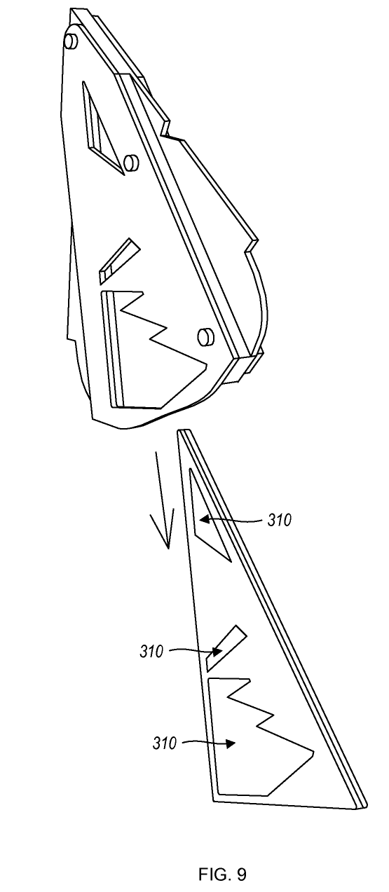

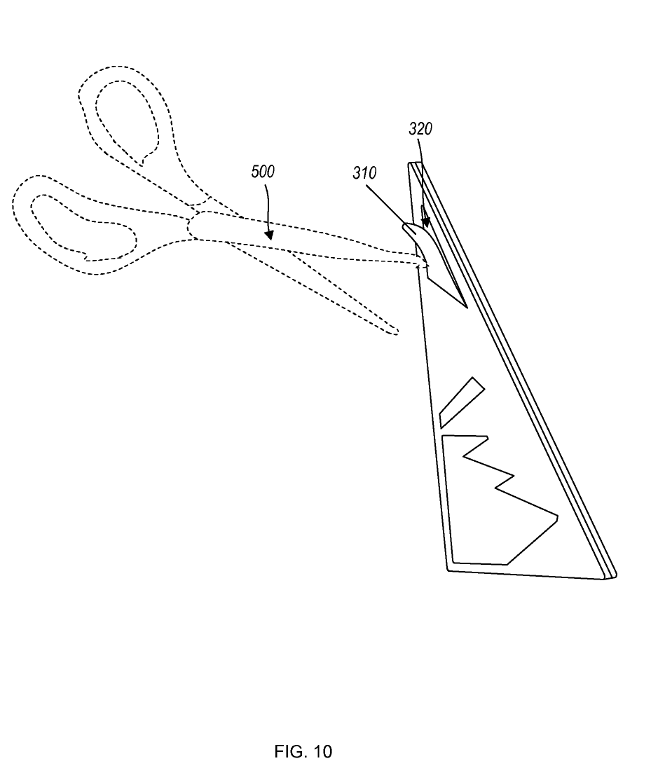

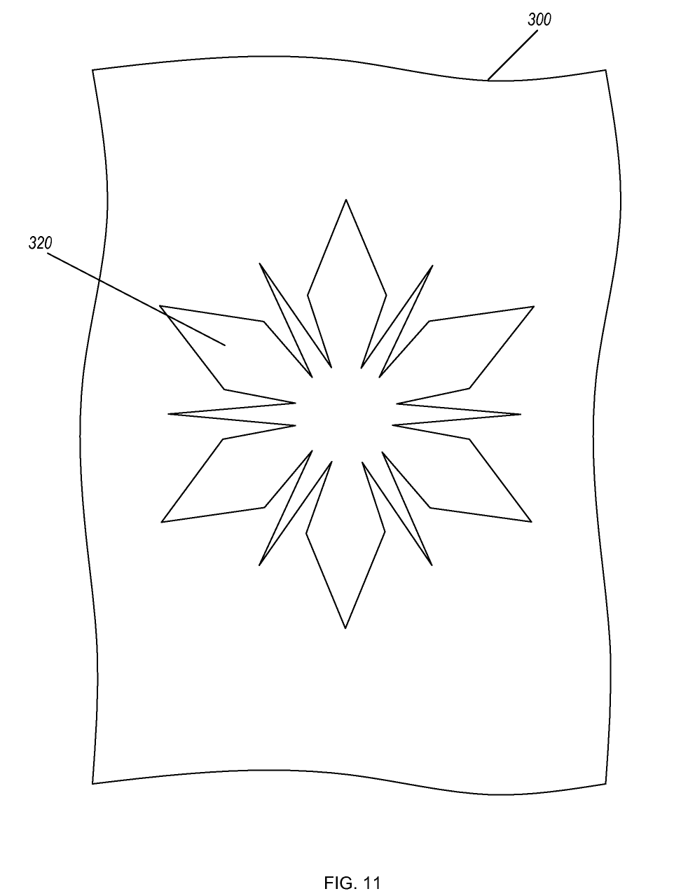

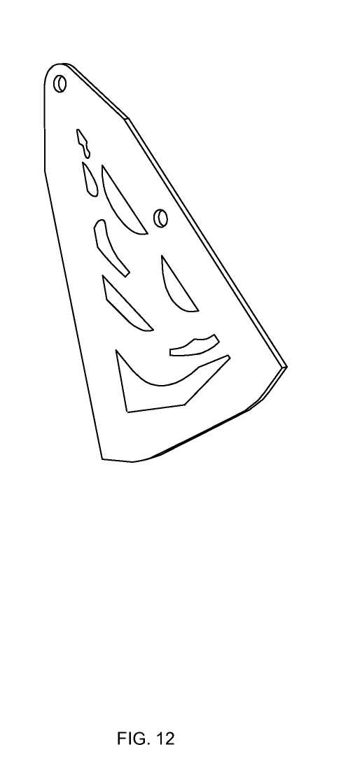

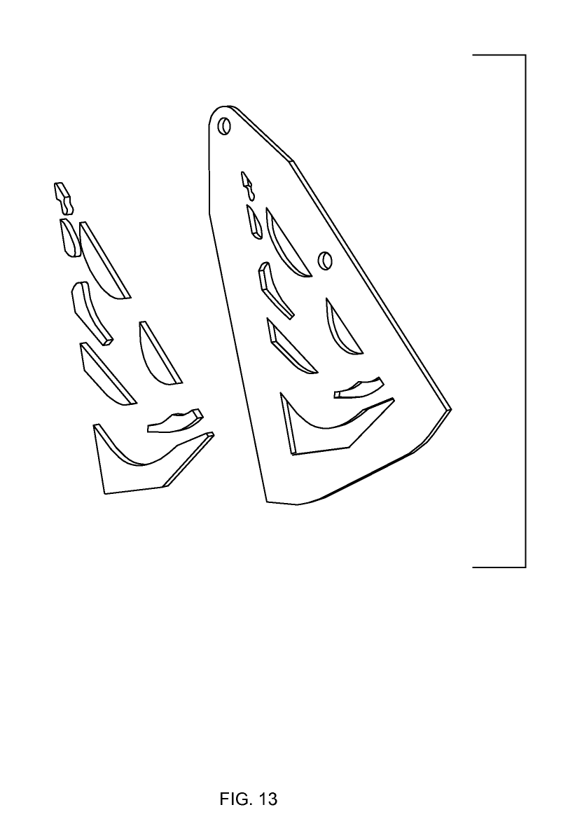

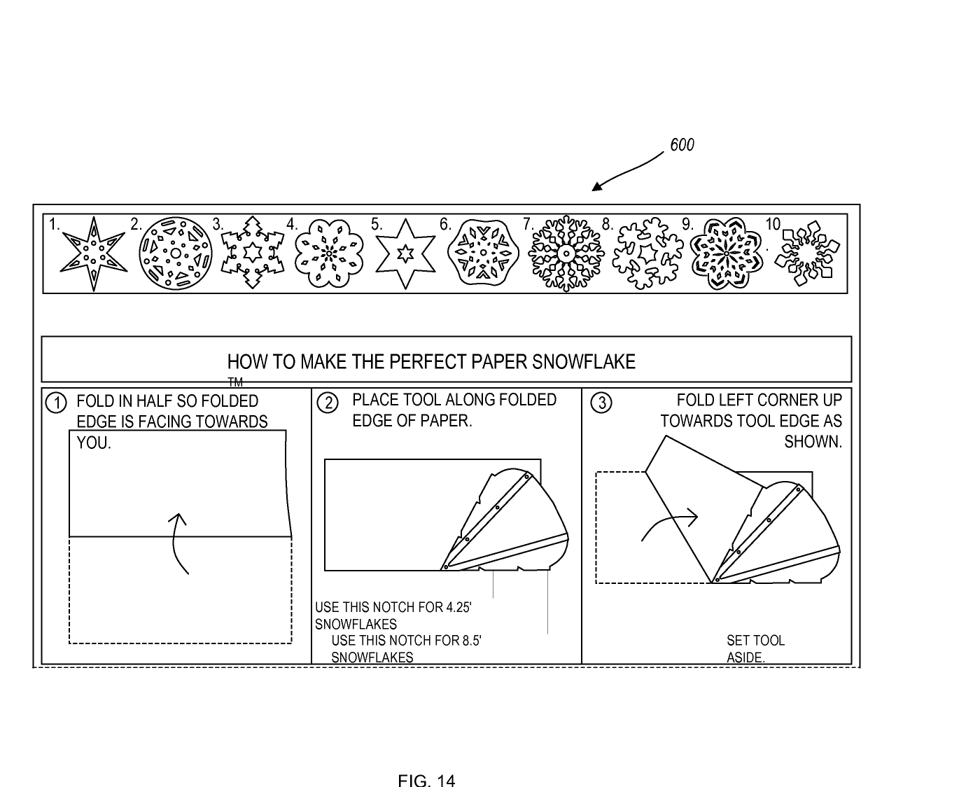

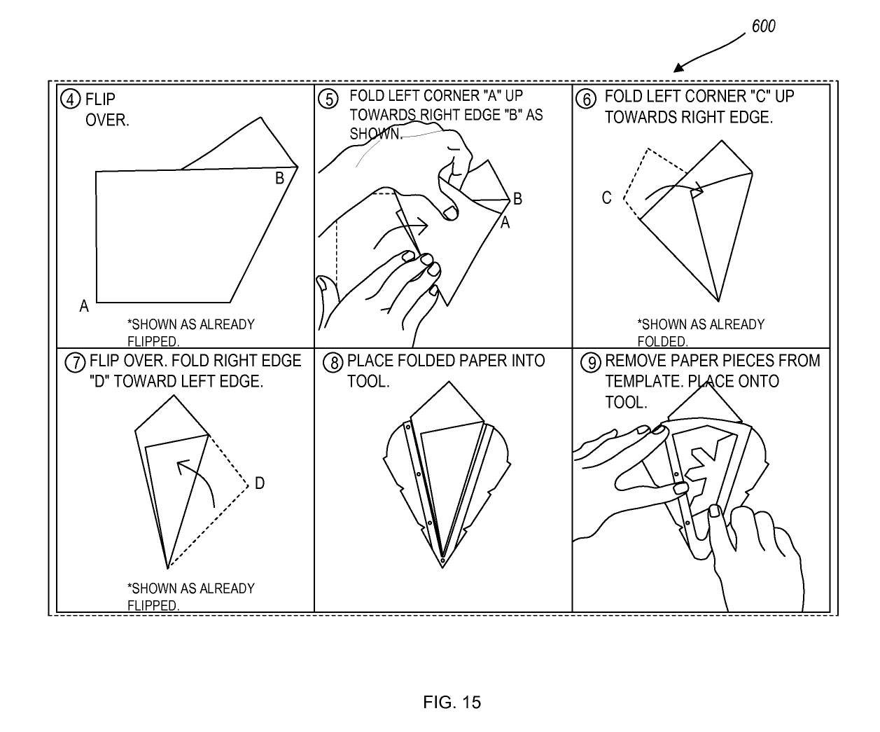

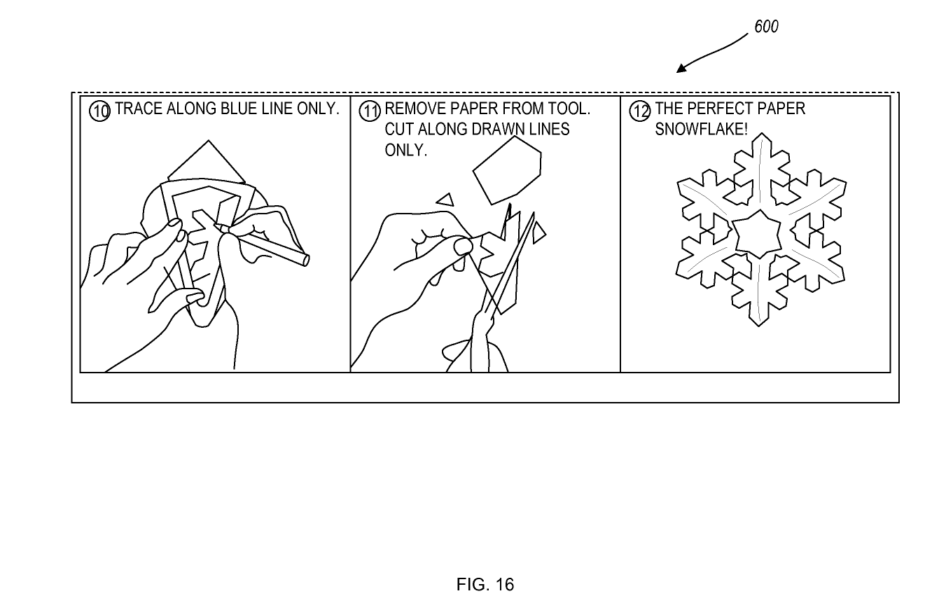

In describing the preferred and other embodiments of the technology described herein, as illustrated in FIG. 1-16, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-16, illustrated therein is a paper craft tool assembly 010.

In an exemplary embodiment the paper craft tool assembly 010 is comprised of a paper craft tool 100.

The paper craft tool 100 is formed as a single piece, having a base 110 that is formed generally in the shaped of a triangle with a rounded bottom section, a right side having an array of notched indentions, a corresponding left side having corresponding notched indentions (a first left side notch 160 and a second left side notch 170), a first raised support 120 having an array of peg supports 140 disposed thereon, and a second raised support 130 without an array of peg supports.

The first raised support 120 and second raised support 130 have their proximal ends equidistant from each other at the rounded bottom section and their distal ends intersect and combine into the point of the triangular apex 150 of the paper craft tool 100. The result of this angled combination of the first raised support 120 and second raised support 130 is to form a recess 180 between the first raised support 120 and second raised support 130 and the top side of the base 110 of the paper craft tool 100 therebetween. This recess 180 provides an insertion area for corresponding sized folded paper 300.

The paper craft tool assembly 010 is further comprised of at least one marking template 200. The marking template 200 is dimensioned for secure placement onto the paper craft tool 100, with the marking template 200 having an array of holes 230 corresponding to the array of pegs 140 on the paper craft tool 100. In one embodiment the marking template 200 is comprised of punch-out sections 210 that are removed by a user prior to use in order to form marking openings 220. The marking template 200 can be formed of metal, e.g., aluminum or stainless steel, plastic, cardboard, paper, or other suitable material. In some embodiments of the technology described herein the marking template 200 is formed with marking openings 220 with no punch-out sections 210.

The paper craft tool assembly is further comprised of an instruction sheet 600, illustrating the proper method of folding a sheet of paper 300 in preparation for marking and cutting.

When a paper has been properly folded and inserted into the recess 180 of the paper craft tool 100 and a marking template 200 is securely placed over the combination of the paper craft tool 100 and folded paper 300, a marking instrument 400, e.g. a pencil, is used to trace onto the folded paper 300 an area to be removed by a cutting instrument 500, e.g. by scissors, knife, etc.

The method of using the technology described herein is comprised of
a. Obtaining a paper craft tool, a marking template, a square sheet of paper, a marking instrument and a cutting instrument;
b. Folding the sheet of paper in half to create a folded edge;
c. Placing the paper craft tool along the folded edge with the apex of the paper craft tool on the folded edge and the left side notch (matching the paper size) aligning with the proximal end of the right vertical side of the folded paper;
d. Folding the left corner of the paper towards the paper craft tool right side such that it is aligned with the paper tool right side;
e. Removing the folded paper and flipping it over;
f. Folding the bottom left corner to align with the right diagonal edge;
g. Folding the top left corner to align with the right diagonal edge;
h. Flipping over the folded paper;
i. Folding the right edge toward the left edge;
j. Placing the folded paper into the paper craft tool recess;
k. Removing punch-out sections from the marking template (if any);
l. Placing the marking template onto the paper craft tool with the folding paper therebetween;
m. Using the marking tool to trace on the folded paper using the punch-out sections as a guide;
n. Removing the folded paper from the paper craft tool recess;
o. Cutting the folding paper along the tracings; and
p. Unfolding the folded paper.

In another embodiment of the technology described herein the method for creating folded and cut paper art comprises:
a. obtaining a paper craft tool, a marking template, a square sheet of paper, a marking instrument and a cutting instrument, the paper craft tool having an apex, a left side, a right side and a left side notch and a paper craft tool recess, the marking template having marking template cavities;
b. folding the paper in half to create a first folded paper having a first folded edge, a right vertical side having a proximal end and a distal end, a left corner;
c. placing the paper craft tool along the first folded edge with the apex of the paper craft tool placed on the first folded edge and the left side notch aligning with the proximal end of the right vertical side of the first folded paper;
d. folding the left corner of the first folded paper towards the paper craft tool right side such that it is aligned with the paper tool right side, creating a second folded paper having a bottom left corner, a right diagonal edge and a top left corner;
e. removing the second folded paper and flipping the second folded paper over;
f. folding the bottom left corner to align with the right diagonal edge;
g. folding the top left corner to align with the right diagonal edge to form a third folded paper;
h. flipping over the third folded paper having a right edge and a left edge;
i. folding the right edge toward the left edge to form a fourth folded paper;
j. placing the fourth folded paper into the paper craft tool recess;
k. placing the marking template onto the paper craft tool with the fourth folded paper therebetween;
l. using the marking tool to create a plurality of tracings on the fourth folded paper using the marking template cavities as a guide;
m. removing the fourth folded paper from the paper craft tool recess;
n. cutting with the cutting instrument the fourth folded paper along the plurality of tracings; and
o. unfolding the fourth folded paper.

Reference Number Table

| Ref. # | Description |
|---|---|
| 010 | Paper Craft Tool Assembly |
| 100 | Paper Craft Tool |
| 110 | Paper Craft Tool Base |
| 120 | First Raised Support |
| 121 | First Raised Support Cavity |
| 130 | Second Raised Support |
| 131 | Second Raised Support Cavity |
| 140 | Peg |
| 150 | Apex |
| 160 | First Left Side Notch |
| 170 | Second Left Side Notch |
| 180 | Recess |
| 200 | Marking Template |
| 210 | Punch-Out Section |
| 220 | Marking Template Opening |
| 230 | Marking Template Peg Hole |
| 300 | Paper |
| 310 | Marked Section |
| 320 | Removed Section |
| 400 | Marking Instrument |
| 500 | Cutting Instrument |
| 600 | Instruction Sheet |

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered in the appended claims.

I claim:

1. A method for creating folded and cut paper art, the method comprising:
a. obtaining a paper craft tool, a marking template, a square sheet of paper, a marking instrument and a cutting instrument, the paper craft tool having an apex, a left side, a right side and a left side notch and a paper craft tool recess, the marking template having marking template cavities;
b. folding the paper in half to create a first folded paper having a first folded edge, a right vertical side having a proximal end and a distal end, a left corner;
c. placing the paper craft tool along the first folded edge with the apex of the paper craft tool placed on the first folded edge and the left side notch aligning with the proximal end of the right vertical side of the first folded paper;
d. folding the left corner of the first folded paper towards the paper craft tool right side such that it is aligned with the paper tool right side, creating a second folded paper having a bottom left corner, a right diagonal edge and a top left corner;
e. removing the second folded paper and flipping the second folded paper over;
f. folding the bottom left corner to align with the right diagonal edge;
g. folding the top left corner to align with the right diagonal edge to form a third folded paper;
h. flipping over the third folded paper having a right edge and a left edge;
i. folding the right edge toward the left edge to form a fourth folded paper;
j. placing the fourth folded paper into the paper craft tool recess;
k. placing the marking template onto the paper craft tool with the fourth folded paper therebetween;
l. using the marking tool to create a plurality of tracings on the fourth folded paper using the marking template cavities as a guide;
m. removing the fourth folded paper from the paper craft tool recess;
n. cutting the fourth folded paper along the plurality of tracings; and
o. unfolding the fourth folded paper.

2. A paper craft tool comprising:
a. a base dimensioned generally in the shaped of a triangle the base having
i. a rounded bottom section,
ii. a right side having an array of notched indentions,
iii. a corresponding left side having corresponding notched indentions, the right side and the left side proceed from the rounded bottom and terminate at an apex,
iv. a first raised support having a first proximal end and a first distal end and an array of peg supports disposed thereon, and
v. a second raised support having a second proximal end and a second distal end, the first proximal end and second proximal end are equidistant and terminate at the rounded bottom section, and the first distal end and second distal end intersect and combine into the apex, and
vi. a recess formed between the first raised support and the second raised support.

3. The paper craft tool of claim 2, further comprising:
a. a first raised support and
b. a second raised support.

4. The paper craft tool of claim 3, further comprising:
a. at least one peg disposed on the first raised support.

5. The paper craft tool of claim 4, further comprising:
a. the left side having at least one notch.

6. The paper craft tool of claim 5, further comprising:
a. The right side having at least one notch.

7. A system for creating paper craft, the system comprising:
a. a paper craft tool; and
b. at least one marking template,

8. The system of claim 7, further comprising:
a. the paper craft tool comprising:
i. a base dimensioned generally in the shaped of a triangle the base having
1. a rounded bottom section,
2. a right side having an array of notched indentions,
3. a corresponding left side having corresponding notched indentions, the right side and the left side proceed from the rounded bottom and terminate at an apex,
4. a first raised support having a first proximal end and a first distal end and an array of peg supports disposed thereon, and
5. a second raised support having a second proximal end and a second distal end, the first proximal end and second proximal end are equidistant and terminate at the rounded bottom section, and the first distal end and second distal end intersect and combine into the apex, and
6. a recess formed between the first raised support and the second raised support;
b. the at least one marking template further comprising:
i. an array of peg holes configured for insertion of the peg supports, and
ii. at least one marking template cavity.
